(19) United States
(12) Patent Application Publication
(10) Pub. No.: US 2010/0287243 A1
(43) Pub. Date: Nov. 11, 2010

(54) INTERACTIVE MESSAGE SERVICE

(75) Inventor: Sander Bakker, Herten (NL)

Correspondence Address: MICHAELSON & ASSOCIATES, P.O. BOX 8489, RED BANK, NJ, 07701-8489, US

(73) Assignees: KONINKLIJKE KPN N.V., The Hague (NL); STREAM GROUP BV, Herten (Roermond) (NL)

(21) Appl. No.: 12/448,986

(22) PCT Filed: Jan. 29, 2008
(86) PCT No.: PCT/EP2008/000663

§ 371 Date: Jul. 27, 2010

Related U.S. Application Data
(60) Provisional application No. 60/898,634, filed on Jan. 31, 2007.

(30) Foreign Application Priority Data
Feb. 15, 2007 (EP) 07003199.2

(51) Int. Cl. G06F 15/16

(52) U.S. Cl. 709/206

(57) ABSTRACT

A set-top box of a first subscriber facilitates creation of a first message to alert a second subscriber to content, e.g., a live broadcast, then occurring. The first message is sent to a server on the Internet. The server creates a second message based on the first message and sends the second message to a set-top box of the second subscriber. The set-top box of the second subscriber alerts that subscriber to the second message. Upon opening the second message, the second subscriber can interact with interactive features contained in the second message so as to facilitate tuning to the content indicated by the first subscriber.

### FIELD OF THE INVENTION

The invention relates to a method of providing a communication service via a data network.

### BACKGROUND ART

In a community, whether real or virtual, people like to share experiences and information. For example, when a person is watching a television broadcast that he/she believes is of interest to one or more friends or acquaintances, he/she would like to notify the other person about this broadcast. That person could make short telephone calls to the others in order to alert them. Doing so, however, is rather cumbersome for that person, as he/she has to withdraw his/her attention from the broadcast, find his/her telephone and the relevant telephone numbers, and then expend precious time making the calls.

### SUMMARY OF THE INVENTION

The invention addresses the above and other problems, and provides a solution that, among other things, reduces user intervention in the process of alerting other people to available content information (hereinafter simply referred to as “content”).

To this end, the invention provides a method of providing a communication service via a data network, such as the Internet. The method comprises receiving, from a user, a first message via the data network. The first message has information about content, currently being rendered at electronic equipment of the user, and an identifier of an addressee. The method further involves sending a second message to electronic equipment of the addressee via the data network. The second message enables the addressee to render the content upon a specific interaction of the addressee with the second message. The invention thus provides a service and an infrastructure to facilitate notifying of friends and acquaintances, while advantageously requiring much less user intervention than in the conventional telephone scenario briefly discussed above.

Preferably, the method involves providing a list of multiple addressees. The list is configured for being rendered at the electronic equipment of the user so as to let the user select one or more addressees for the second message.

The second message has an interactive feature that enables its addressee to render the content information upon the specific interaction with the feature. Accordingly, the first message preferably triggers the creation of the second message that is provided with interactive features so as to facilitate the interaction with the addressee.

In an embodiment of the invention, the content contains a live broadcast, e.g., a live TV broadcast. The second message then has an identifier of the live broadcast. Upon the specific interaction of the addressee with the second message, the second message controls the further electronic equipment to tune it to the live broadcast.

An illustrative scenario according to the invention is as follows. A set-top box of a first subscriber facilitates creation of a first message to alert a second subscriber to a live broadcast then occurring. The first message is sent to a server on the Internet. The server creates a second message based on the first message and sends it to a set-top box of the second subscriber. The set-top box of the second subscriber alerts the latter to the second message. Upon opening the second message, the second subscriber can interact with interactive features contained in the second message so as to facilitate tuning to the live broadcast indicated by the first subscriber.

### BRIEF DESCRIPTION OF THE DRAWING

The invention is explained in further detail, by way of example and with reference to the accompanying drawing, wherein:

FIG. 1 depicts a block diagram of a system which embodies the present invention;

FIG. 2 diagrammatically depicts, through a process diagram, the inventive method; and

FIG. 3 depicts a block diagram of apparatus used in the system shown in FIG. 1.

Throughout the figures, similar or corresponding features are indicated by same reference numerals.

### DETAILED EMBODIMENTS

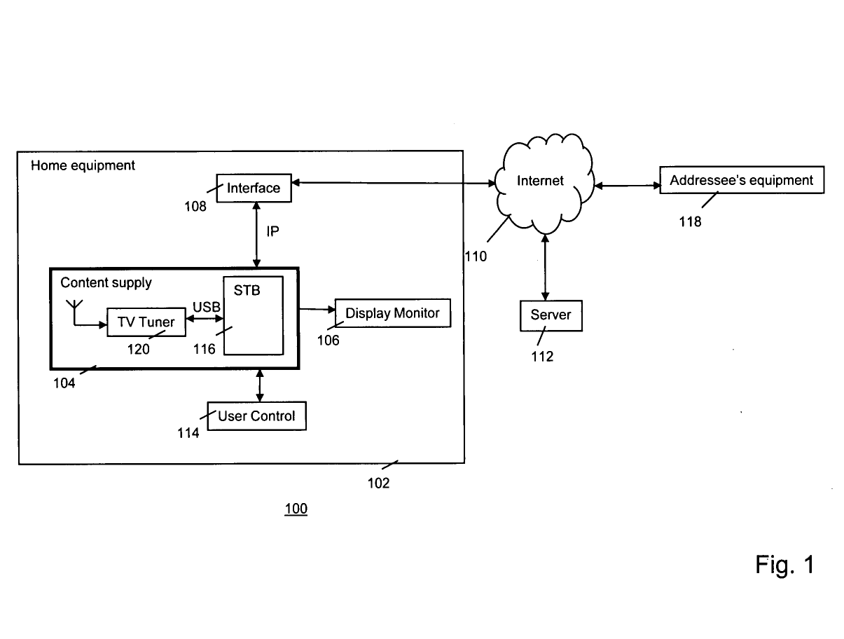

FIG. 1 depicts a block diagram of inventive system 100. System 100 has electronic home equipment 102 that includes content supply sub-system 104. Sub-system 104 is connected to display monitor 106 and to data network interface 108 that communicates via data network 110, e.g., the Internet, to data center, or server, 112. System 100 further has user control interface 114, e.g., a remote control, for enabling a user to control, as discussed below, operation of equipment 102. System 100 also includes addressee's equipment 118 connected to data network 110.

Content supply sub-system 104 comprises, e.g., set-top box (STB) 116 connected to TV tuner 120 via a USB port. Sub-system 104 may also comprise a home media storage (not shown) that stores and/or processes the user's personal content, such as home videos, video games, slide show, photograph pictures, DVDs, CDs, etc. Interface 108 comprises, e.g., a modem (not specifically shown) for Internet Protocol (IP) data traffic.

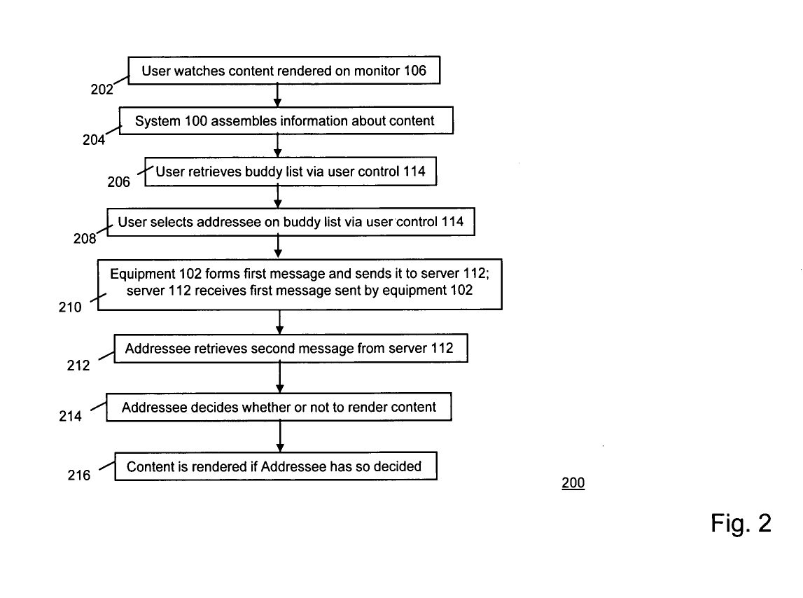

FIG. 2 is a process diagram illustrating the invention's functionality within the context of a service 200 provided in system 100 of FIG. 1.

In step 202, the user of equipment 102 is watching content being rendered on display monitor 106, or is listening to content information being played out on a loudspeaker (not shown).

In step 204, system 100 assembles information (meta-information) about the content then being rendered. This can be done locally at equipment 102. For example, where the content is a live broadcast, meta-information regarding this live broadcast can be retrieved, e.g., from side-band information contained in the broadcast or from an electronic program guide (EPG). Illustratively, the EPG contains the meta-information per program item per channel which may be rendered in a grid-like overview on display monitor 106. Alternatively, the assembling of the meta-information can be achieved by having equipment 102 send to server 112 an identifier of the content that is currently being rendered. The identifier comprises, e.g., a channel number of the broadcast currently being watched and local time, thus enabling server 112 to identify the broadcast via a program guide. The channel number can be provided by STB 116 directly or by interpreting the control commands from user control 114. As another example, the identifier may have an identifier of a CD or DVD then being played, or a local address of an electronic file stored at home equipment 102, etc.

In step 206, the user retrieves a buddy list from system 100 by means of specific user interaction provided through user control 114. Preferably, user control 114 has a dedicated user input feature for initiating retrieval of the list. For example, user control 114 may have a remote control device with dedicated buttons to facilitate user control over the list retrieval. The buddy list is, e.g., a personal list of the user that lists names or nicknames of other users having their home equipment (here, e.g., equipment 118) also connected, via data network 110, to server 112. Each name on the list has a specific network address. The list may reside at home equipment 102, e.g., at STB 116. Alternatively, the list may reside at server 112 and be retrieved through home equipment 102, e.g., STB 116, upon a specific user interaction with user control 116. Alternatively, the list of names resides at equipment 102, and its associated list of network addresses resides at server 112 in the form of, e.g., an associated look-up table. This server-resident approval may, to some extent, provide advantages with regard to privacy. The buddy list has preferably been compiled by the user him/herself in a configuration mode of home equipment 102. Alternatively, the buddy list has been compiled by server 112 upon user input, e.g., through a dedicated web site. The list is preferably rendered on monitor 106 at which the content information is being played out.

In step 208, the user selects a name or addressee then appearing on the buddy list. Selection may again be performed through a dedicated user interaction through user control 114, e.g., by means of up/down arrows on the keypad of user control 114 so as to move a highlight up or down the buddy list, and an “enter” key to confirm selection, or via a suitably configured universal touch screen remote control.

In step 210, equipment 102, e.g., STB 116, compiles a first message and sends it to server 112. The first message identifies the addressee or multiple addressees selected by the user of equipment 102 in step 208, and also identifies the content currently being rendered at home equipment 102. Preferably, the user can add personal remarks to the message, e.g., selected from a menu displayed together with or in association with the buddy list, and prepared in advance. A typical remark can be: “please watch <program title> on channel <channel number or call sign>”. The entities “program title” and “channel number or call sign” are filled in by system 100, e.g., by STB 116, once the content being rendered to the user becomes known to system 100. Alternatively, the user can type in a message via a keyboard included in user control 114. When the buddy list has been retrieved, STB 116 is in an operational mode wherein it interprets the keystrokes as text for inclusion in the message.

In step 212, a second message can be retrieved from server 112 by the addressee on his/her home equipment 118, e.g., his/her STB (not shown). While addressee's home equipment 118 has been turned off or is in a sleep mode, that equipment preferably provides an indication that a second message has been received and is now available. The addressee can respond through specific interaction with equipment 118 in order to retrieve the message. For example, the addressee has an STB (not shown), compatible to STB 116, which assists in providing the service according to this invention. The addressee's STB has lights or other visual indicators on its front panel that alert the addressee to the fact that a new message arrived and is then available. If the addressee then turns on his/her home equipment 118, the display monitor (not shown) of that home equipment renders an icon which the addressee may click on via his/her user control interface (not shown) in order to retrieve and display this message. Alternatively, if the message is received while addressee's home equipment 118 is turned on, home equipment 118 renders an icon on an active display monitor, with which the addressee can then interact to enable the message to be rendered. Preferably, the icon and the message are rendered on addressee's display monitor in a suitably non-intrusive manner. For example, the icon and/or message can be rendered in a strip or region located near a top of an active display area.

The first message sent by equipment 102 to server 112 and the second message retrieved by equipment 118 from server 112 are not necessarily identical. For example, if the user of equipment 102 has selected multiple addressees from the buddy list, each of the selected addressees does not need to be informed about who else is receiving an alert from this user about the same content information. Illustratively, the first message has identifiers of the addressees and an identifier of relevant content, i.e., meta-information. The meta-information can be compiled at equipment 102 itself. The meta-information can, in another embodiment of the invention, also be compiled at server 112 once the identifier of the content is known, and then inserted into the second message. The second message may also preferably have interactive features that facilitates interaction between the addressee and the service upon receipt by the addressee.

In step 214, the addressee selects whether or not to have the content information, indicated in the message, rendered by his own equipment 118. To this end, the message may contain, for example, a sub-menu with first and second graphical buttons. The first button is for starting a rendering process, the second button is for discarding the second message, both operations being under script-control. Other buttons may be available, e.g., for sending a “thank you” reply to the user who initiated the buddy alert process, or for requesting comments, or for continuing a dialog during the rendering, etc.

In step 216, if the addressee has decided to have the content rendered, the addressee can interact with a first one of the buttons to initiate a process wherein the content indicated in the message is then rendered. If that content is a currently broadcasted television program, addressee's home equipment 118, e.g., his/her STB, retrieves the channel number or call sign from the message and switches his/her television set (not shown) to the program then indicated in the message. If the content is personal content of the user of equipment 102, addressee's home equipment 118 retrieves the identifier for this content. If the identifier is a local network address at home equipment 102 of the user who initiated the buddy alert process, the addressee is enabled to download, via server 112, an electronic file of content that has been identified as currently being rendered by the user of equipment 102.

Process 200 in FIG. 2 depicts step 204 as preceding steps 206 and 208. Alternatively step 204 may start assembling information after step 206 where the user retrieves the buddy list, or after step 208 where the user selects an addressee from the buddy list. The step of assembling information is then performed after the user has indicated to equipment 102 that he/she intends to send a first message to server 112 for alerting one or more addressees on the buddy list. An advantage of these alternatives is that information assembly does not occur all the time and only starts once the user is prepares to send the first message, thus conserving computing power and/or processing bandwidth.

Further, server 112 may be replaced with a plurality of servers. This, in turn, allows all messages, of the type discussed above and sent by users from their respective electronic equipment, to be guaranteed to arrive on all servers. Consequently, it does not matter as to which specific one of the servers sends a message. Each particular one of the listed addressees of all buddy lists has corresponding electronic equipment that can be configured to request the second message, intended for this particular addressee, to be received on startup of his/her equipment. This means that messages are delivered immediately to their addressees. Messages are received in such a manner that they are delivered to the intended addressees exactly once (though after a reboot, messages can be repeated when requested).

The second message to the addressee may be rendered on a display monitor as a graphical overlay over other content which that addressee is currently watching. Preferably, the second message is rendered in a way so that it does not obscure that content. The second message occupies screen real-estate that is preferably relatively small compared to an active area of the display. Combined with this approach or alternatively, a semi-transparent overlay can be used.

The service process implemented by the present invention is initiated by the user, of equipment 100, who wants to alert a buddy to specific content then currently available. The infrastructure required for providing a service to carry out the processes described above can equally well be employed to broadcast or multicast public notifications, e.g., in case of issuing a community-wide claim that might illustratively arise due to a threat of a looming disaster caused by an approaching thunderstorm or tornado, a large-scale accident, etc. The initiator is then not necessarily a user of electronic home equipment watching a particular broadcast, but could illustratively be a community official who instructs server 112 to multicast the message to specific people on the list to whom the alarm could be relevant. Similarly, advance notifications can be sent to relevant parties on the buddy list in case of upcoming programs that the initiator believes might be of interest to these parties. The upcoming programs of interest could be determined through, e.g., an EPG. Doing so advantageously utilizes the meta-information about the programs available from the EPG and in electronic format, which, in turn, can either be pasted in the message to be distributed or identified through a pointer inserted in that message. In the latter case, the EPG may reside at server 112 or another server (not shown).

Preferably, the inventive service provided through server 112 is based on a subscription fee. Server 112 keeps history logs of all subscribers who have been initiating and/or receiving the messages, for, e.g., billing or problem reporting purposes.

Preferably, the notification of the addressee via data network 110 and server 112, for all practical purposes, is practically instantaneous. Since some conventional email services may introduce delays, that may render a service in accordance with the invention less attractive for the simple reason that real-time aspect of information sharing, provided by the present invention, may be diminished.

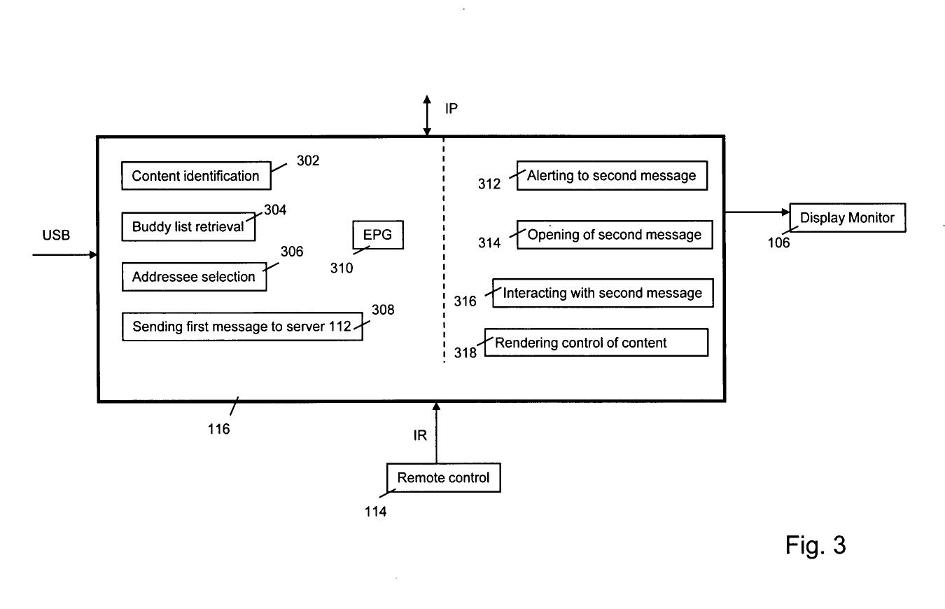

FIG. 3 depicts a detailed block diagram of electronic apparatus 116, in this example an STB, forming a functional component of system 100 (see FIG. 1). STB 116 could also be implemented by a general-purpose computer with suitable software and an IR (infra-red) sensor. Apparatus 116 is assumed to be capable of sending first messages to server 112 and of retrieving or receiving second messages from server 112. Users having subscribed to the service explained above can be provided with a uniform apparatus to conduct interactive messaging as used in the present invention.

Apparatus 116, as shown in FIG. 3, has first means 302 for identifying the content being currently rendered via apparatus 116 as explained above; second means 304 for retrieving a list of addressees upon receiving a first user command from user control 114, here an IR remote control device; third means 306 for selecting one or more of the addressees upon receipt of a second user command from remote control 114; and fourth means 308 for, upon receipt of a third user command from remote control 114, sending via data network 110 to server 112 the first message identifying the one or more selected addressees and identifying the content. Preferably, apparatus 116 is configured for processing content in the form of a live broadcast and comprises an EPG 310 to facilitate assembling the meta-information about a program being currently watched, as explained above. Means 302-310 are preferably implemented using software, running on a dedicated STB or a general-purpose personal computer (PC), although some or all of means 302-310 could be implemented in hardware.

Preferably, apparatus 116 also comprises fifth means 312 for alerting the user to a new second message addressed to him/her. This apparatus also has sixth means 314 for opening the second message, seventh means 316 for interacting with the second message and eighth means 318 for controlling the rendering of the content identified in the second message. User interaction is accomplished, e.g., through remote control 114. Means 312-318 are also preferably implemented using software, although some or all of means 312-318 could be implemented in hardware.

As is clear from the above description, the combined functionalities of system 100 that enable to run a service according to the present invention, can be distributed among various physical entities, e.g., apparatus 116 and, server 112, and in various different modalities. Only a few suitable illustrative implementations have been described above; those skilled in the art can readily derive many others that still incorporate the present inventive teachings. Distribution of the required functionalities between physical entities may be determined by e.g., costs, efficiency, user-friendliness, maintenance and support issues, quality of service issues, etc. All associated considerations leading to a desired distribution fall well within the competencies of that person of skill.

1. A method of providing a communication service via a data network, the method comprises the steps of:
receiving, at a server connected to the network and from electronic equipment associated with a user, a first message via the data network, the first message having information specifying content then currently being rendered at the electronic equipment of the user, and an identifier of an addressee; and
sending, from the server and in response to receipt of the first message, a second message to electronic equipment of the addressee via the data network, the second message enables the addressee to render the content upon a specific interaction of the addressee with the second message.

2. The method of claim 1 further comprising the step of providing a list of multiple addressees, the list being configured for being rendered at the electronic equipment of the user such that the user is able to select one or more addressees for the second message.

3. The method of claim 1 wherein the second message comprises an interactive feature that enables the addressee to render the content upon the specific interaction with the feature.

4. The method of claim 1 wherein:
the content comprises a live broadcast;
the second message comprises an identifier of the live broadcast; and
upon the specific interaction of the addressee with the second message, the second message controls the electronic equipment of the addressee to tune to the live broadcast.

5. An electronic apparatus comprising:
first means for identifying content currently being rendered via the apparatus;
second means for retrieving, upon a first user command, a list of addressees;
third means, responsive to the second means, for selecting, upon a second user command, one or more of the addressees;
fourth means, responsive to a third user command and to said first and third means, for sending via a data network to a server a first message identifying the one or more selected addressees and identifying the content.

6. The apparatus of claim 5 wherein the content comprises a live broadcast and the apparatus comprises an electronic program guide for use by the first means, in identifying the content.
